(19) United States
(12) Patent Application Publication
(10) Pub. No.: US 2004/0128821 A1
(43) Pub. Date: Jul. 8, 2004

(54) Method for manufacturing a ball head polygonal wrench

(76) Inventor: Ming-Yuan Huang, Chang Hua Hsien (TW)

Correspondence Address: CHARLES E. BAXLEY, ESQUIRE, Hart, Baxley, Daniels & Holton, 5 Fl, 59 John St, New York, NY, 10038, US

(21) Appl. No.: 10/336,321

(22) Filed: Jan. 2, 2003

(51) Int. Cl. B23P 13/04

(52) U.S. Cl. 29/558

(57) ABSTRACT

A method for manufacturing a star-shaped ball head polygonal wrench includes step 1 to step 3. Step 1 is to obtain a cylindrical body. Step 2 is to cut the near end portion of the cylindrical body to form a neck portion. Step 3 is to roll the head and neck portion of the cylindrical body to form a ball head.

### FIELD OF THE INVENTION

The present invention relates to a method for manufacturing a ball head polygonal wrench, and more particularly to a method for manufacturing a star-shaped ball head polygonal wrench.

### BACKGROUND OF THE INVENTION

The conventional method for manufacturing a ball head polygonal wrench is by the use of planning or/and cutting, as shown in FIG. 1, which generally includes step 1 to step 5. Step 1 is to prepare a cylindrical rod. Step 2 is to cut a head portion and a neck portion on the cylindrical rod by a lathe. Step 3 is to position the cylindrical rod at a precise manner. Step 4 is to plane six sides on the head portion of the cylindrical rod by a planer. Step 5 is to remove burrs on the head portion and the neck portion. Although the ball head polygonal wrench can be manufactured by this commonly used, there are still some drawbacks need to be improved:

First, in the conventional method, as shown in FIG. 2, a side of a drive head portion 11 is cut out by repeated cutting of a planer10, then the rest five sides of the drive head portion 11 have to be made out in turn by the planer10 cooperating with a precision positioning instrument with rotating function to rotate an integral drive shank portion 12 in constant angle. However, the cost of the precision positioning instrument is very high and the manufacturing process is also very complicated.

Second, the conjunctions between each sides of the drive head portion 11 are rough and need to be cleared, which make the process more complicated.

Third, the planer 10 is worn out by the repeated planning and cutting process, so it needs to be grinded and maintained very often, which increase the costs.

Finally, by the conventional method, the planer 10 can't make star-shaped ball head polygonal wrench due to the sides of the drive head are all curve-shaped.

Moreover, although the star-shaped ball head polygonal wrench may be made out by forging tools, the conjunctions between each sides of the drive head portion 11 is still rough and the drive head portion 11 can not be made at one time, the manufacturer needs to add a step of cleavage to smooth the conjunctions, which makes the process become more complicated.

The present invention has arisen to mitigate and/or obviate the afore-described disadvantages of the conventional process for making a spherical wrench head.

### SUMMARY OF THE INVENTION

In accordance with the present invention, there is provided a new method for manufacturing a ball head polygonal wrench and comprising three steps which are step 1: material obtaining step: obtaining a cylindrical body; step 2: lathe turning step: lathe cutting the near end portion of the cylindrical body to form a neck portion, and step 3 rolling step: rolling the head and neck portion of the cylindrical body to form a ball head.

The primary object of the present invention is to provide a method for manufacturing a ball head polygonal wrench, in particularly, a star-shaped ball head polygonal wrench.

Another object of the present invention is to provide a method in order to reduce the costs of ball head manufacturing and simplify the procedures of production.

The further object of the present invention is to provide a method in order to effectively maintain the rolling mill used in step 3 of the method and prolong the life of the rolling tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a flow chart to show a conventional method.

FIG. 2 is an illustrative view to show a conventional working process for manufacturing a spherical wrench head.

FIG. 3 is a flow chart illustrating the steps of the method of the present invention.

FIG. 4 is an illustrative view in accordance with the present invention to show a cylindrical rod material.

FIG. 5 is an illustrative view in accordance with the present invention to show the process of cutting a wrench head.

FIG. 6 is an illustrative view to show the relative position of the rollers and the cylindrical body is formed by a rolling mill.

FIG. 7 is a perspective view to show a final product of a wrench head.

FIG. 8 is an illustrative view to show the relative position of the rollers and the cylindrical body is formed by another rolling mill.

FIG. 9 is an illustrative view to show the relative position of the rollers and the cylindrical body is formed by yet rolling mill.

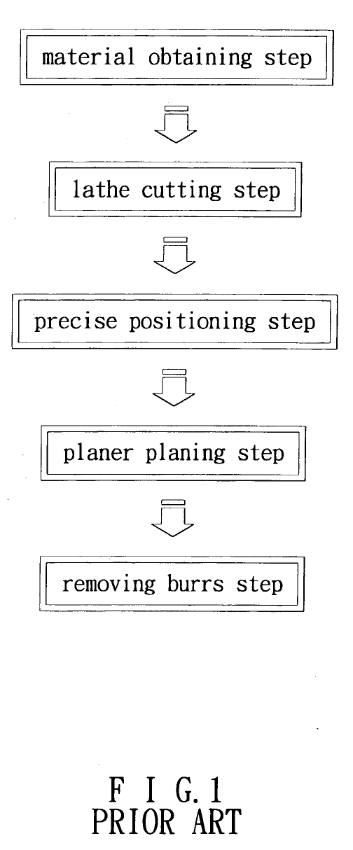

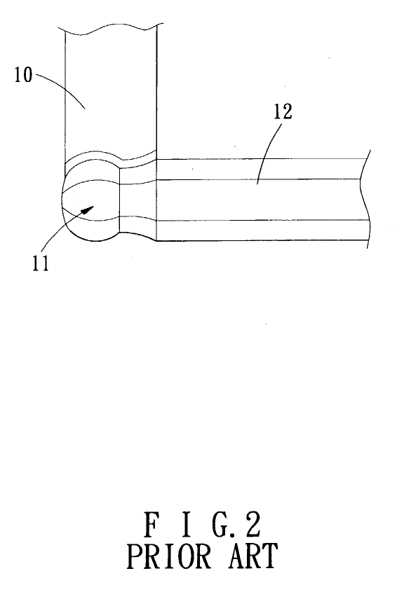

### DETAILED DESCRIPTION OF THE PREFERRED EMBODIMENTS

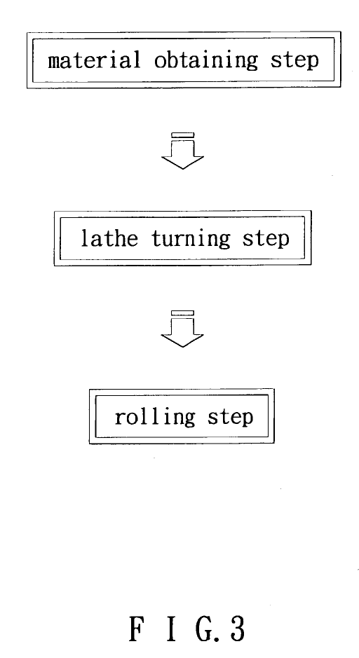

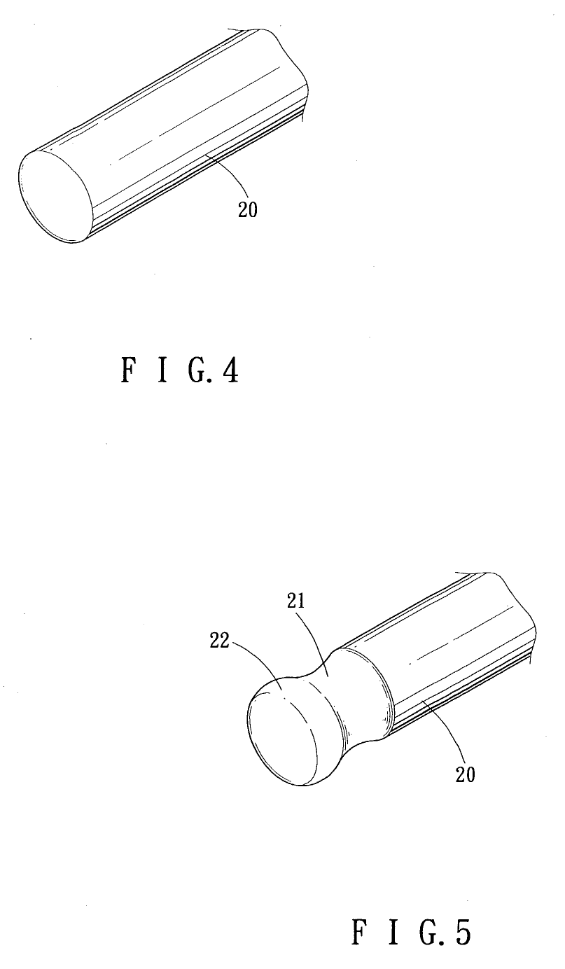

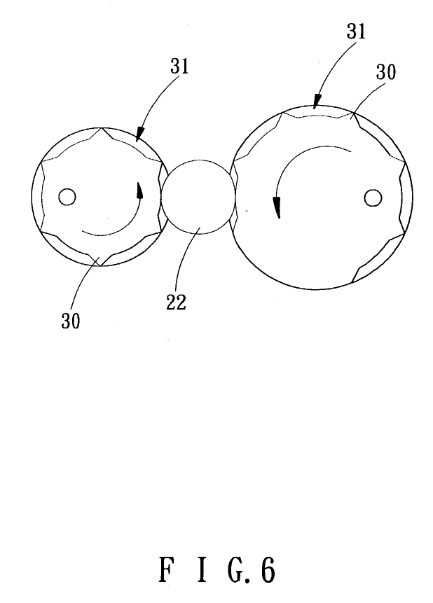

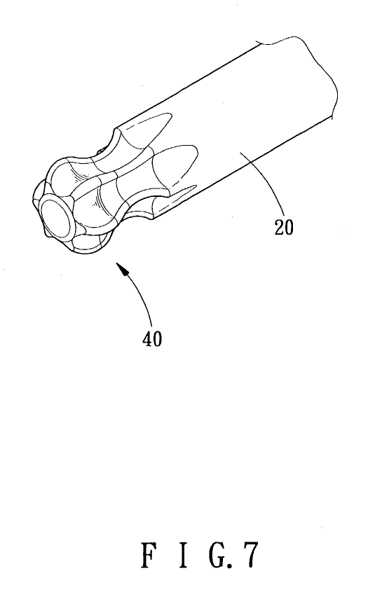

Referring to FIG. 3, the method for manufacturing a ball head polygonal wrench in accordance with the present invention comprises step 1 to step 3. Step 1 is to obtain a cylindrical body 20 as shown in FIG. 4. Step 2 is to cut the near end portion 22 of the cylindrical body 20 to form a neck portion 21 by way of a lathe and/or to cut the end 22 of the cylindrical body 20 to form a ball head by way of the lathe at the same time. As shown in FIG. 5, in this time, the sizes of the ball head portion 22 and the neck portion 21 are bigger than the size of the final product. Step 3 is to roll the head portion 22 of cylindrical body 20 to form a star-shaped head 40 as shown in FIG. 7. Referring to FIG. 6, the ball head portion 22 of the cylindrical body 20 is located between two rollers 30 of a rolling mill, each of the two rollers 30 of the rolling mill has a circular rolling mould 31, then the rollers 30 are eccentrically pressed and rotate adversely to roll the ball head portion 22 and the neck portion21 of the cylindrical body 20 to form a star-shaped ball head 40 which is shown in FIG. 7. There is no burr will appear on the star-shaped ball head 40 due to the star-shaped is rolled out at one time, in addition, no precision positioning instrument with rotating function used in the method of the present invention, so the cost is reduced to the least. Also, the rolling mill used in the method of the present invention will be prolonged in duration due to the neck portion 21 of the cylindrical body 20 is concavely lathe cut before rolling process, in this case, the stress on the circular rolling mould 31 is not heavy during the rolling process.

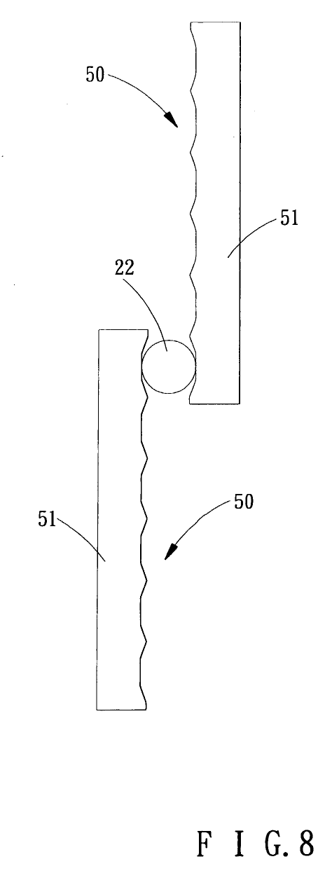

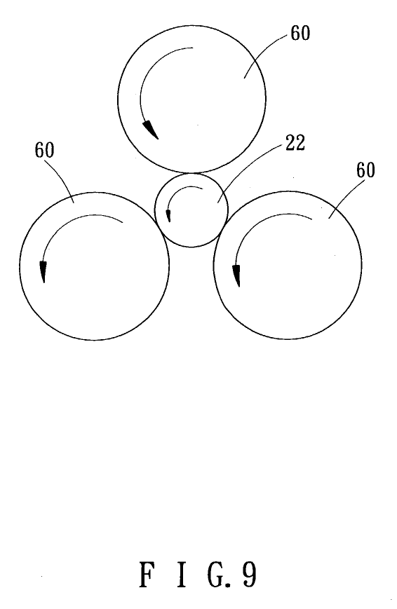

Furthermore, in accordance with present invention, besides the above described instrument can be used for manufacturing a star-shaped spherical wrench head, other instruments, such as plane mould 51 and three rollers 60 (as shown in FIGS. 8-9) can be used as well. The plane mould 51 of a rolling mill 50 (as shown in FIG. 8) can also manufacture the six sides of the star-shaped ball head 40 at one time by locating the ball head portion 22 of the cylindrical body 20 between the surfaces of the plane mould 51 of the rolling mill 50 and then compressed by a great pressure. And more, the three rollers 60 as shown in FIG. 9 can also manufacture the six sides of the star-shaped ball head 40 at one time by the same method of the present invention.

While we have shown and described the embodiments in accordance with the present invention, it should be clear to those skilled in the art that further embodiments may be made without departing from the scope of the present invention.

What is claimed is:

1. A method for manufacturing a ball head polygonal wrench comprising the following steps:
step 1: material obtaining: obtaining a cylindrical body;
step 2: lathe turning step: lathe cutting the near end portion of the cylindrical body to form a neck portion;
step 3: rolling step: rolling the head and neck portion of the cylindrical body to form a ball head.

2. The method as claimed in claim 1, wherein said ball head is star-shaped.

3. The method as claimed in claim 1, wherein said head and neck portion of said cylindrical body are rolled by two opposite rollers, said two opposite rollers each has a circular rolling mould formed on a periphery thereof.

4. The method as claimed in claim 1, wherein said head and neck portion of said cylindrical body are rolled by two opposite plane moulds.

5. The method as claimed in claim 1, wherein said head and neck portion of said cylindrical body are rolled by three rollers.

6. The method as claimed in claim 1, wherein said head and neck portion of the cylindrical body may be cut by lathe at the same time, the sizes of the head and the neck portion are bigger than the size of the final product.
